(19) United States
(12) Patent Application Publication
(10) Pub. No.: US 2017/0092966 A1
(43) Pub. Date: Mar. 30, 2017

(54) TREATMENT DEVICE FOR TREATING EXHAUST GAS OF A FUEL CELL STACK, FUEL CELL SYSTEM AND VEHICLE WITH A FUEL CELL SYSTEM

(71) Applicant: DAIMLER AG, Stuttgart (DE)

(72) Inventors: Leif-Patrik BARTHEL, Süßen (DE); Simon HOLLNAICHER, Albershausen (DE); Alfred KOLBE, Hattenhofen (DE)

(73) Assignee: DAIMLER AG, Stuttgart (DE)

(21) Appl. No.: 15/310,940

(22) PCT Filed: May 13, 2015
(86) PCT No.: PCT/EP2015/000991

§ 371 Date: Nov. 14, 2016

(30) Foreign Application Priority Data
May 20, 2014 (DE) 10 2014 007 677.6

(51) Int. Cl. H01M 8/04119; H01M 8/0662

(52) U.S. Cl. CPC H01M 8/04141; H01M 8/0662; H01M 8/04164; H01M 2250/20

(57) ABSTRACT

A treatment device for treating exhaust gases of a fuel cell stack of a fuel cell system is provided. A humidifier, in which the exhaust gas is usable for humidifying a medium capable of being introduced into the fuel cell stack, includes a water separator for reducing a content of liquid water in the exhaust gas. The humidifier and the water separator are integrated in a common constructional unit. An outflow area of the humidifier has a cross-section capable of being passed, which is larger than a cross-section of an inflow area of the humidifier capable of being passed. The constructional unit includes at least one collection area for the liquid water separated upon exit from the outflow area.

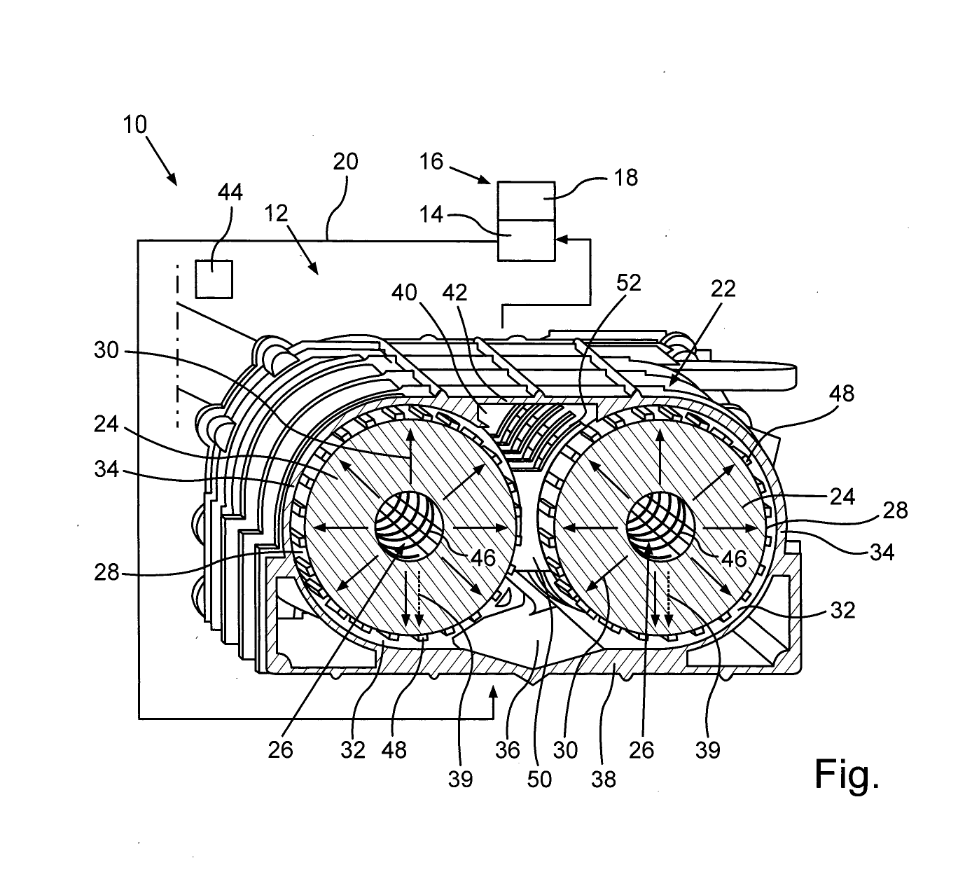

### BACKGROUND AND SUMMARY OF THE INVENTION

Exemplary embodiments of the invention relate to a treatment device for treating exhaust gas of a fuel cell stack of a fuel cell system. The treatment device includes a humidifier, which is adapted to utilize the exhaust gas for humidifying a medium capable of being introduced into the fuel cell stack. Furthermore, a water separator is provided, which serves for reducing a content of liquid water in the exhaust gas. The humidifier and the water separator are integrated in a common constructional unit. Furthermore, the invention relates to a fuel cell system with such a treatment device and to a vehicle with a fuel cell system.

German patent document DE 101 10 419 A1 describes a fuel cell system in which a hollow fiber membrane humidifier is disposed upstream of a fuel cell. Exhaust gas of the fuel cell is supplied to the humidifier as a humidifying medium. The hollow fiber membrane humidifier and a steam/liquid separator downstream of the same can be integrated to decrease the pressure loss in the outlet pipe of the fuel cell.

United States patent document US 2005/0045043 A1 describes a humidifier for a fuel cell system. A water separator is also disposed in a housing receiving tubes with a desiccant. A wet medium flows through interstices between the tubes containing the desiccant, which thus absorb humidity. The stored humidity is then absorbed by another medium, which also flows through the humidifier. The medium serving for humidifying is set in a rotational movement by means of a turbulator after flowing through the interstices between the tubes such that liquid water droplets are separated from it. The collected liquid water is drained from the housing of the humidifier via an outlet.

Such treatment devices for treating exhaust gas require comparatively much space and a considerable number of components.

Therefore, exemplary embodiments of the present invention are directed to a treatment device of the initially mentioned kind, a fuel cell system with such a treatment device as well as a vehicle with such a fuel cell system, which entail(s) a particularly low installation space requirement.

In the treatment device according to the invention, an outflow area of the humidifier has a cross-section capable of being passed by the exhaust gas, which is larger than a cross-section of an inflow area of the humidifier capable of being passed. Furthermore, at least one collection area for the liquid water separated upon exit from the outflow area is provided in the constructional unit. This is based on the realization that by enlarging the cross-section capable of being passed in the area of the humidifier serving for transferring humidity, a deceleration of the flow of the exhaust gas is achieved. This results in a reliable separation of the liquid water without requiring a particularly high run length.

Thus, the circumstance is utilized that with a geometry of the humidifier, which is associated with an increasing cross-section capable of being passed, a decelerated flow is present in the humidifier. In the outflow area, the exhaust gas has the very low flow velocity associated therewith, and it exits on a comparatively large area in well distributed manner. By this deceleration of the flow velocity of the exhaust gas, a particularly efficient separation of liquid water can be achieved in the outflow area.

The low exit velocity of the exhaust gas in the outflow area is therefore utilized to perform the separation of liquid water at this place and directly following in the treatment device.

However, even within the distance from the inflow area to the outflow area and/or in the inflow area itself, efficient separation of liquid water with the aid of gravity and due to density differences is achievable. Namely, a separation of liquid water already occurs while the exhaust gas flows from the inflow area towards the outflow area of the humidifier.

Since the function of the water separator is thus integrated in the humidifier, the present installation space is particularly efficiently utilized and particularly much installation space can be saved compared to a consecutive arrangement of humidifier and water separator in a constructional unit. This is also associated with saving of components otherwise to be provided for water separation. Thus, the cost associated with these components can also be reduced.

In an advantageous configuration, the inflow area is formed as a channel, which is disposed in a bundle of hollow fiber membranes capable of being passed by the exhaust gas in radial direction. Herein, the outflow area is constituted by an outside of the bundle. Then, the exhaust gas flows from the channel towards the outside of the—preferably substantially round—bundle such that comparatively much liquid water can be separated already within the bundle. In addition, separation of liquid water already occurs in the channel itself and in particular in transition from the channel into the area of the hollow fiber membranes constituting the bundle.

A particularly uniform low flow velocity and a particularly good distribution of the exhaust gas exiting the bundle at the outside thereof is achievable if the channel is disposed centrally in the bundle. This too is conducive to the separation of liquid water.

It has proven further advantageous if a clearance communicating with the at least one collection area for the liquid water is provided between the outside of the bundle and a housing wall of the constructional unit. Via this clearance, the exhaust gas at least largely freed of liquid water can be particularly unimpeded discharged from the treatment device on the one hand. On the other hand, thus, the liquid water separated from the exhaust gas can arrive at the collection area for the liquid water in simple manner and reliable in terms of process. This improves the functionality of the treatment device. Furthermore, a separation of liquid water arises on the housing wall of the constructional unit bounding the clearance.

Preferably, a plurality of webs is provided, which abut on the outside of the bundle on the one hand and on the housing wall on the other hand. Such webs support the bundle from the outside and thus ensure stabilization, in particular ensuring dimensional stability of the bundle. In addition, the size of the clearance can be well adjusted by the height of the webs.

In order to particularly well satisfy the above mentioned functions, the webs are disposed in the clearance uniformly spaced from each other in circumferential direction of the bundle.

Further, it is conducive to the stability of the bundle if a supporting structure is provided, which supports the hollow fiber membranes of the bundle surrounding the channel. Thus, the function of the channel as the inflow area with a desired cross-section capable of being passed can also be simply and permanently ensured.

A particularly unimpeded transition of the exhaust gas from the channel into the bundle, in which the exhaust gas flows around the hollow fiber membranes on the outer circumferential side, is achievable if the supporting structure is formed in the manner of a coil spring.

Furthermore, it is advantageous if the bundle has a substantially round form, wherein at least a bottom-side part of a housing of the constructional unit has at least one corner area, by which the at least one collection area for the liquid water is constituted. The formation of the constructional unit in angular, in particular rectangular, manner at least in the lower part facilitates the manufacture thereof and its arrangement in the fuel cell system. In addition, the corner areas otherwise unused with a round bundle presently can be particularly well utilized, namely for collecting the liquid water. Thus, the liquid water does not impede the flow of the exhaust gas through the bundle of the hollow fiber membranes.

A particularly low pressure loss in the exhaust gas path is achievable if two bundles are disposed in a housing of the constructional unit. Namely, a shorter path then has to be traveled from the inflow area to the outflow area in a respective of the two bundles than in providing a single bundle with a number of hollow fiber membranes, which corresponds to that of both bundles.

In addition, in such a configuration of the treatment device, the at least one collection area for the liquid water can be formed in a recess of a bottom of the housing provided between the two bundles. Thus, the space between the two bundles can also be well utilized, namely for collecting the separated liquid water. This in particular applies if the, for example round, bundles are symmetrically disposed and/or if the recess is V-shaped formed.

With an accommodation of two bundles in the housing of the constructional unit, in a space between the two bundles and a ceiling area of the housing, at least one further collection area for the exhaust gas at least largely freed of liquid water can be provided. Thus, this upper clearance between the two preferably round bundles can be used as an outflow area for the dry exhaust gas.

Finally, it has proven advantageous if a retaining structure is provided, which keeps the two bundles spaced from each other. Namely, the space between the two bundles can thus be particularly well used for collecting the liquid water and for collecting the dry exhaust gas thus at least largely freed of liquid water.

Such a retaining structure can have at least one stiffening element encompassing the respective bundle at least in certain areas. This retaining structure then ensures stable retention of the bundles and dimensional stability thereof.

The fuel cell system according to the invention, which can in particular be employed in a vehicle, includes a treatment device according to the invention. Herein, the exhaust gas of a cathode of the fuel cell stack is preferably usable in the humidifier for humidifying an oxidant capable of being introduced into the cathode of the fuel cell stack. Furthermore, it is advantageous if the exhaust gas at least largely freed of liquid water is supplied to a turbine of an exhaust gas turbocharger of the fuel cell system via a line. In that dry exhaust gas is supplied to the turbine, it is not damaged, and in particular freezing of the turbine is effectively prevented.

Such a fuel cell system can include a plurality of further components usual in particular for fuel cell systems of vehicles, which presently do not have to be explained in detail.

The vehicle according to the invention includes a fuel cell system according to the invention.

The advantages and preferred embodiments described for the treatment device according to the invention also apply to the fuel cell system according to the invention and to the vehicle according to the invention.

The features and feature combinations mentioned above in the description as well as the features and feature combinations mentioned below in the description of figures and/or shown in the figures alone are usable not only in the respectively specified combination, but also in other combinations or alone, without departing from the scope of the invention. Thus, implementations are also to be considered as encompassed and disclosed by the invention, which are not explicitly shown in the figure or explained, but arise from and can be generated by separated feature combinations from the explained implementations.

### BRIEF DESCRIPTION OF THE DRAWING FIGURES

Further advantages, features and details of the invention are apparent from the claims, the following description of preferred embodiments as well as based on the drawing.

The sole FIGURE shows a hollow fiber humidifier of a fuel cell system for a vehicle in a partially sectioned view, wherein the hollow fiber humidifier is formed as a water separator at the same time.

### DETAILED DESCRIPTION

Of a fuel cell system 10 of a vehicle, a humidifier 12 is shown in the FIGURE, which serves for humidifying an oxidant to be provided for the fuel cell reaction. This oxidant can for instance be oxygen or air. The humidified air exits the humidifier 12 and is supplied to a cathode 14 of a fuel cell stack 16 of the fuel cell system 10. An anode 18 of the fuel cell stack 16 can be supplied with hydrogen as the fuel for the fuel cell reaction occurring in the fuel cell stack 16. Presently, the exhaust gas of the cathode 14 containing the product water formed in the fuel cell reaction is supplied to the humidifier 12 as a humectant. A corresponding exhaust gas line 20 is schematically shown in the FIGURE.

Separation of liquid water from the exhaust gas occurs at the same time in the humidifier 12. Thus, the humidifier 12 and a water separator are integrated in a common constructional unit in that both humidifying the supply air and removing liquid water from the exhaust gas occur within a common housing 22.

Two fiber bundles 24 are disposed in the housing 22 of the humidifier 12, the two fiber bundles 24 each include a plurality of hollow fiber membranes. In the center of the respective fiber bundle 24, an inflow area in the form of a channel 26 is provided, via which the wet exhaust gas of the cathode 14 gets into the respective fiber bundle 24. The individual hollow fibers surrounding the respective channel 26 are oriented parallel to the respective channel 26. The supply air to be humidified flows through these hollow fibers, which is then passed on from the humidifier 12 to the cathode 14 of the fuel cell stack 16.

The exhaust gas of the cathode 14 flows in the humidifier 12 from the respective channel 26 in radial direction towards an outside 28 of the—presently round formed—respective fiber bundle 24. An outflow area is provided by this outside 28 of the respective fiber bundle 24, in which the exhaust gas has a decelerated flow velocity and exits the respective fiber bundle 24 well distributed on a large area.

The deceleration of the flow velocity of the exhaust gas is caused in that the cross-section available in the channel 26 capable of being passed, which corresponds to the lateral surface of the respective channel 26, is less than the cross-section available in the area of the outside 28 capable of being passed. This increase of the cross-section capable of being passed on the path from the channel 26 to the outside 28 results in reduction of the flow velocity.

Due to the deceleration of the flow velocity, liquid water is separated on the outside 28 of the respective fiber bundle 24. The low exit velocity from the respective fiber bundle 24 is therefore used to directly subsequently perform the separation of liquid water.

The direction of the exhaust gas flowing in radial direction from the inflow area constituted by the channel 26 towards the outside 28 is illustrated by arrows 30 in the FIGURE. On the path from the channel 26 towards the outside 28, the wet exhaust gas flows around the membranes of the hollow fibers, through which the supply air to be humidified flows. Herein, the humidification of the supply air occurs. In addition, water is also separated in flowing through the way from the channel 26 towards the outside 28.

In the channel 26 formed in the manner of a pipe extending longitudinally through the fiber bundle 24 too, separation of liquid water already occurs. A preferred direction, in which the separated liquid water moves due to the gavity and due to a density difference related to gaseous components of the exhaust gas, is illustrated by a further arrow 39 in the respective fiber bundle 24 in the FIGURE.

The radial exit of the exhaust gas from the channel 26 is effected in that the hollow fiber membranes of the respective fiber bundle 24 can be passed by the supply air to be humidified in the axial direction of the channel 26, however, in comparison, the respective channel 26 is closed on the end side. At the axial end of the channel 26, namely, the individual hollow fiber membranes of the respective fiber bundle 24 are passed through an end plate closing the channel 26, which is preferably formed by a casting compound.

The liquid water separated on the outside 28 of the respective fiber bundle 24 gets from a clearance 32 formed between a housing wall 34 of the housing 22 and the outside 28 of the respective fiber bundle 24 to a collection area 36 for liquid water. Presently, the collection area 36 is formed as a V-shaped recess in a bottom 38 of the housing 22. This groove-shaped recess is located centrally between the two fiber bundles 24 symmetrically disposed in the housing 22. The liquid water can be drained from the collection area 36 via an outlet (presently not shown).

Presently, the housing 22 is adapted to the contour of the round fiber bundles 24 disposed next to each other in an upper area, however, a bottom-side partial area of the housing 22 is formed cuboid-shaped. However, presently, the otherwise unused corner areas arising in accommodation of one or two round fiber bundles 24 in the housing 22 with the cuboid-shaped partial area can be used for collecting the separated liquid water.

A space 40 in the housing 22 too, which is bounded by upper partial areas of the fiber bundles 24 and a ceiling area 42 of the housing 22, is presently used, namely for discharging the dry exhaust gas, thus the exhaust gas, from which the liquid water was at least largely separated. From the upper collection area provided by this space 40, the dry exhaust gas then flows towards a turbine 44 of an exhaust gas turbocharger, the compressor wheel of which compresses the supply air supplied to the humidifier 12 in a manner presently not shown in more detail.

A supporting structure is preferably provided in each fiber bundle 24, which ensures that the respective channel 26 has a good dimensional stability. This supporting structure can be formed as a coil spring 46. Presently, the coil spring 46 abuts on the hollow fiber membranes, which immediately surround the channel 26.

Webs 48 extending in the axial direction of the respective channel 26 ensure the clearance 32 is kept free and thus the good capability of being passed thereof for the dry exhaust gas, which are disposed on the outside 28 of the respective fiber bundle 24.

Furthermore, between the two fiber bundles 24, a retaining structure 50 is provided, which keeps the two fiber bundles 24 spaced from each other. This retaining structure 50 additionally has ribs 52, which encompass the respective fiber bundle 24 in circumferential direction at least to a certain extent and thus serve for stiffening the respective fiber bundle 24. The ribs 52 are uniformly spaced from each other in the axial direction of the respective channel 26. In corresponding manner, the webs 48 are disposed on the outside 28 of the respective fiber bundle 24 uniformly spaced from each other in circumferential direction.

In alternative embodiments, a single fiber bundle 24 can be disposed in a housing, the corner areas of which can be used for collecting separated liquid water and for discharging the dry exhaust gas.

In addition, with a hollow fiber humidifier formed in the manner of the humidifier 12 shown in the FIGURE with integrated water separator, the fuel to be supplied to the fuel cell stack 16 can also be humidified.

Although the present invention has been described above by means of embodiments with reference to the enclosed drawings, it is understood that various changes and developments can be implemented without leaving the scope of the present invention, as it is defined in the enclosed claims.

### LIST OF REFERENCE CHARACTERS

10 Fuel cell system
12 Humidifier
14 Cathode
16 Fuel cell stack
18 Anode
20 Exhaust gas line
22 Housing
24 Fiber bundle
26 Channel
28 Outside
30 Arrow
32 Clearance
34 Housing wall
36 Collection area
39 Arrow
38 Bottom
40 Space
42 Ceiling area
44 Turbine
46 Coil spring
48 Web
50 Retaining structure
52 Rib

1-10. (canceled)

11. A treatment device for treating exhaust gas of a fuel cell stack of a fuel cell system, the treatment device comprising:
a humidifier configured to receive and humidify the exhaust gas and provide the humidified exhaust gas the fuel cell stack; and
a water separator configured to reduce a content of liquid water in the received exhaust gas,
wherein the humidifier and the water separator are integrated in a common constructional unit,
wherein an outflow area of the humidifier has a cross-section through which the exhaust gas passes, the cross-section is larger than a cross-section of an inflow area of the humidifier through which the exhaust gas passes, and
wherein the common constructional unit further comprises at least one collection area configured to receive the liquid water separated upon exiting the outflow area.

12. The treatment device of claim 11, wherein the inflow area is a channel disposed in a substantially round bundle of hollow fiber membranes through which the exhaust gas passes in a radial direction, wherein an outside of the bundle constitutes the outflow area.

13. The treatment device of claim 12, wherein a clearance is arranged between the outside of the bundle and a housing wall of the common constructional unit, wherein the clearance communicates with the at least one collection area for the liquid water.

14. The treatment device of claim 13, wherein a plurality of webs uniformly spaced from each other in a circumferential direction of the bundle abut on the outside of the bundle and on the housing wall.

15. The treatment device of claim 13, wherein a coil spring supporting structure abuts the hollow fiber membranes of the bundle surrounding the channel.

16. The treatment device of claim 12, wherein the bundle is substantially round, wherein at least a bottom-side part of a housing of the common constructional unit has at least one corner area constituting the at least one collection area for the liquid water.

17. The treatment device of claim 12, wherein two symmetrically disposed bundles are disposed in a housing of the common constructional unit, wherein the at least one collection area for the liquid water is formed in a V-shaped recess of a bottom of the housing provided between the two symmetrically disposed bundles.

18. The treatment device of claim 17, wherein at least one further collection area for the exhaust gas at least largely freed of liquid water is provided in a space between the two symmetrically disposed bundles and a ceiling area of the housing.

19. The treatment device of claim 17, further comprising:
a retaining structure, which maintains a spaced relationship between the two symmetrically disposed bundles, and which has at least one stiffening element encompassing the two symmetrically disposed bundles at least in certain areas.

20. A vehicle fuel cell system, comprising:
a fuel cell stack comprising a cathode;
a treatment device comprising
a humidifier configured to receive and humidify exhaust gas from the cathode of the fuel cell stack and provide the humidified exhaust gas to the cathode of the fuel cell stack; and
a water separator configured to reduce a content of liquid water in the received exhaust gas,
wherein the humidifier and the water separator are integrated in a common constructional unit,
wherein an outflow area of the humidifier has a cross-section through which the exhaust gas passes, the cross-section is larger than a cross-section of an inflow area of the humidifier through which the exhaust gas passes, and
wherein the common constructional unit further comprises at least one collection area configured to receive the liquid water separated upon exiting the outflow area; and
a turbine of an exhaust gas turbocharger arranged to receive exhaust gas from the treatment device that is at least largely freed of liquid water.

21. A vehicle, comprising:
a fuel cell system, which comprises
a fuel cell stack comprising a cathode;
a treatment device comprising
a humidifier configured to receive and humidify exhaust gas from the cathode of the fuel cell stack and provide the humidified exhaust gas to the cathode of the fuel cell stack; and
a water separator configured to reduce a content of liquid water in the received exhaust gas,
wherein the humidifier and the water separator are integrated in a common constructional unit,
wherein an outflow area of the humidifier has a cross-section through which the exhaust gas passes, the cross-section is larger than a cross-section of an inflow area of the humidifier through which the exhaust gas passes, and
wherein the common constructional unit further comprises at least one collection area configured to receive the liquid water separated upon exiting the outflow area; and
a turbine of an exhaust gas turbocharger arranged to receive exhaust gas from the treatment device that is at least largely freed of liquid water.
